(19) United States
(12) Patent Application Publication
(10) Pub. No.: US 2013/0112725 A1
(43) Pub. Date: May 9, 2013

(54) VEHICLE-MOUNTED LIBRARY WORKSTATION

(71) Applicants: Tao Luo, Shenzhen (CN); Jinghong Yang, Shenzhen (CN); Yongdong Wang, Shenzhen (CN); Cuihong Wu, Shenzhen (CN); Zhenxiong Huang, Shenzhen (CN); Qingqiang Lu, Shenzhen (CN); Ying Chen, Shenzhen (CN); Xiaohong Luo, Shenzhen (CN); Guoxun Chen, Shenzhen (CN); Yun Luo, Shenzhen (CN); Furong Bai, Shenzhen (CN); Songlin Wang, Shenzhen (CN); Yanhong Wang, Shenzhen (CN); Xiaojin Peng, Shenzhen (CN)

(72) Inventors: Tao Luo, Shenzhen (CN); Jinghong Yang, Shenzhen (CN); Yongdong Wang, Shenzhen (CN); Cuihong Wu, Shenzhen (CN); Zhenxiong Huang, Shenzhen (CN); Qingqiang Lu, Shenzhen (CN); Ying Chen, Shenzhen (CN); Xiaohong Luo, Shenzhen (CN); Guoxun Chen, Shenzhen (CN); Yun Luo, Shenzhen (CN); Furong Bai, Shenzhen (CN); Songlin Wang, Shenzhen (CN); Yanhong Wang, Shenzhen (CN); Xiaojin Peng, Shenzhen (CN)

(73) Assignee: Tao Luo, Shenzhen (CN)

(21) Appl. No.: 13/490,005

(22) Filed: Jun. 6, 2012

(30) Foreign Application Priority Data
Nov. 3, 2011 (CN) 201120431621.7

(51) Int. Cl. B60R 7/00

(52) U.S. Cl. 224/539

(57) ABSTRACT

The present disclosure discloses a vehicle-mounted library workstation, comprising a shell, on which a books and disks identifying module and a reader card identifying module are arranged; wherein the books and disks identifying module comprises a book reading antenna and a book reader for driving the book reading antenna, decoding and transferring data scanned by the book reading antenna; the book reader and reader card reading device are RFID tags readers; the vehicle-mounted library workstation being connected to a computer while working, wherein the computer controls the reader card identifying module to collect information of the reader card, controls the books and disks identifying module to collect information of the books and disks, and processes the information of the reader card and information of the books or disks to finish operations of borrowing and returning books.

### FIELD OF THE DISCLOSURE

The present disclosure relates to library systems, and more particularly relates to a vehicle-mounted library workstation.

### BACKGROUND OF THE DISCLOSURE

Vehicle libraries are mainly for readers that are too far away from libraries to borrow books and readers that are lack of book resources. In poor and remote districts, because cost of building a library is high while the utilization rate is low, there are very few libraries. The vehicle libraries are very suit for the poor and remote districts because of the convenient mobility and low cost.

The conventional vehicle libraries are based on the Bar Code Identification technology. However, the problem is, while performing borrow or return operation by identifying bar code, the bar code must be faced to a scanner to be identified, so a library administrator needs firstly to find the bar code and secondly to aim the scanner at the bar code to scan, thus the work efficiency is very low. Moreover, the identification accuracy and correctness may be affected by the weariness and clarity of the bar code, such that books and disks may not be identified, which brings trouble in borrowing and returning books and lowers the speed of borrowing and returning books.

### SUMMARY OF THE DISCLOSURE

It is an object of the present disclosure to provide a convenient and costless vehicle-mounted library workstation.

A vehicle-mounted library workstation, comprising a shell, on which a books and disks identifying module and a reader card identifying module are arranged; wherein the books and disks identifying module comprises a book reading antenna and a book reader for driving the book reading antenna, decoding and transferring data scanned by the book reading antenna; the book reader and reader card reading device are RFID tags readers; the vehicle-mounted library workstation being connected to a computer while working, wherein the computer controls the reader card identifying module to collect information of the reader card, controls the books and disks identifying module to collect information of the books and disks, and processes the information of the reader card and information of the books or disks to finish operations of borrowing and returning books.

By arranging books and disks identifying module and reader card identifying module having the RFID function on the shell, the vehicle-mounted library workstation realizes borrowing and returning books. Because of the RFID technology, when the library administrator performs borrowing and returning operation, there is no need to find the bar code and aim it to the scanner, such that the work efficiency is improved. Furthermore, the front assembly of the vehicle-mounted library workstation may be folded or unfolded to work, so it has the advantages of convenience and occupating smaller space.

### BRIEF DESCRIPTION OF THE DRAWINGS

FIG. 1 is a module diagram of a vehicle-mounted library workstation of the present disclosure.

FIG. 2 is a structural schematic view of a vehicle-mounted library workstation of the present disclosure.

FIG. 3 is a 3D schematic view of a side-laid vehicle-mounted library workstation of the present disclosure.

FIG. 4 is a schematic view of a vehicle-mounted library workstation in operation state of the present disclosure.

FIG. 5 is a schematic view of a folded vehicle-mounted library workstation of the present disclosure.

FIG. 6 is a flow chart of borrowing books with a vehicle-mounted library workstation of the present disclosure.

FIG. 7 is a flow chart of returning books with a vehicle-mounted library workstation of the present disclosure.

### DETAILED DESCRIPTION OF THE EMBODIMENTS

The disclosure will be described in detail with the following embodiments and drawings. vehicle-mounted library workstation

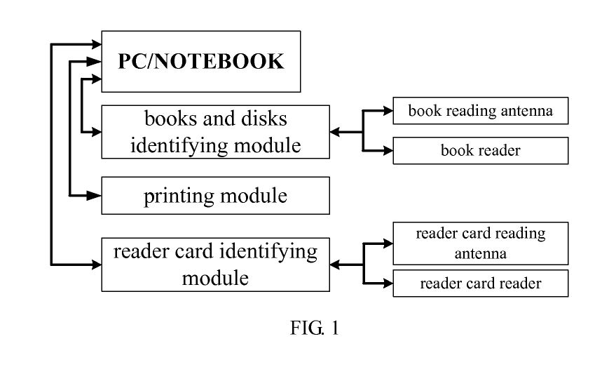

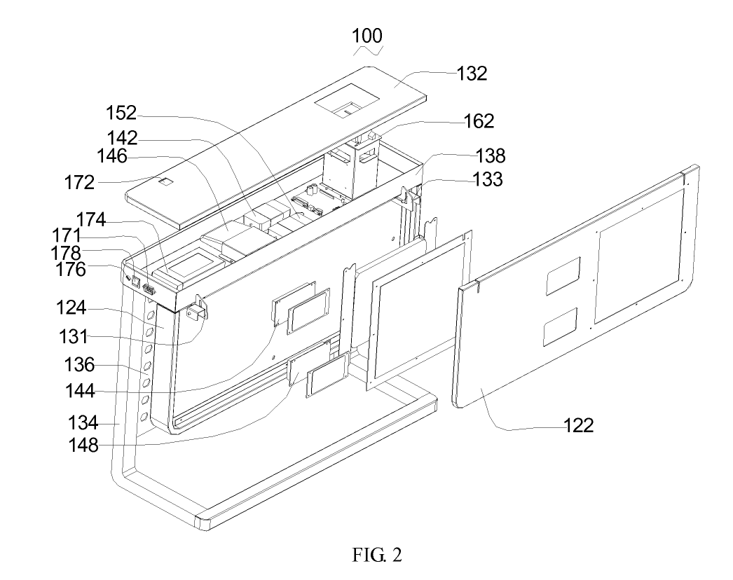

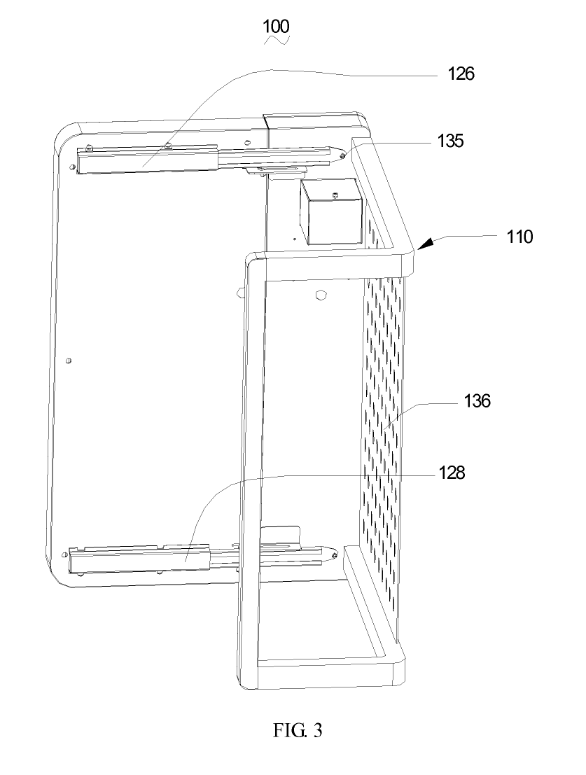

Referring to FIGS. 1 through 4, the present disclosure provides a vehicle-mounted library workstation 100. The vehicle-mounted library workstation includes a shell 110, on which a books and disks identifying module and a reader card identifying module are arranged. The books and disks identifying module includes a book reading antenna 154 and a book reader 152. The book reader 152 is for driving the book reading antenna 154, decoding and transferring data scanned by the book reading antenna 154. The reader card identifying module includes a reader card reading antenna 144 and a reader card reading device 142. The reader card reading device 142 is for driving the reader card reading antenna 144, decoding and transferring data scanned by the reader card reading antenna 144. The book reader 152 and reader card reading device 142 are RFID tags readers, which operate under the RFID technology. The present vehicle-mounted library workstation 100 is connected to a computer while working. The computer controls the reader card identifying module to collect information of the reader card and controls the books and disks identifying module to collect information of the books and disks. The information of the reader card and information of the books or disks are processed to finish operations of borrowing and returning books.

When a reader borrows or returns a book, a library administrator may control the library workstation 100 to work via a notebook. Firstly, the library administrator chooses borrow operation or return operation according to the reader borrowing a book or returning a book. Secondly, the library administrator puts the reader card in a sensing scope of the reader card reading antenna 144. Because there are electrical tags in the reader cards, when the notebook controls the reader card reading device 142 of the reader card identifying module to work, the reader card reading device 142 will drive the reader card reading antenna 144 to read information from the reader card. Thirdly, the library administrator puts the book ready to be borrowed or returned in a sensing scope of the book reading antenna 154. Because there are electrical tags in the books, when the notebook controls the book reader 152 to work, the reader card reading device 142 will drive the book reading antenna 154 to read information from the electric tags disposed in the books. Finally, the computer transmits the obtained information to library management systems to finish the borrow operation or return operation.

The vehicle-mounted library workstation 100 further includes a printing module and a power supply module. The printing module includes a thermo-sensitive printer 162 used to print receipts of borrowing or returning books for the reader. The power supply module includes an input plug seat 171, a seesaw switch 178, a fusing member 176, a switching power supply 174 and a 3-socket seat 172. The power is input to the input plug seat 171, flows in sequence through the seesaw switch 178 and the fusing member 176, and then branches to two paths to the switching power supply 174 and the 3-socket seat 172 respectively. In other words, the input plug seat 171, the seesaw switch 178 and the fusing member 176 are connected in series, and then connected the parallel connected switching power supply 174 and the 3-socket seat 172. The voltage of the power through the switching power supply 174 will be lowered to provide power source to the book reader 152, the reader card reading device 142 and the thermo-sensitive printer 162. The 3-socket seat 172 is connected to an adaptor of the notebook to provide power source. Further, the vehicle-mounted library workstation 100 includes an identification card reader 146 and an antenna 148. The identification card reader 146 and antenna 148 may be used to create a reader card. The identification card reader 146 drive the antenna 148 to work, and decodes data scanned by the antenna 148, then transmits the data to the notebook for further processing.

The shell 110 of the vehicle-mounted library workstation 100 is substantially U-shaped. The shell 110 includes a front assembly and a rear assembly. The front assembly includes a front top cover plate 122, a front bottom plate 124, a first supporting and contracting assembly 126 and a second supporting and contracting assembly 128. The rear assembly includes a rear top cover plate 132, a bottom support assembly 134, a decoration plate 136, a rear bottom plate 138, a first curved connecting plate 131, a second curved connecting plate 133 and a screw 135. Wherein the bottom plate 138 is fixed on the top of the bottom support assembly 134, the decoration plate 136 is fixed at a side of the bottom support assembly 134. The rear top cover plate 132 is fixed on the bottom plate 138 to form a house for housing the power supply module, the print module, the reader card reading device 142, the identification card reader 146 and the book reader 152.

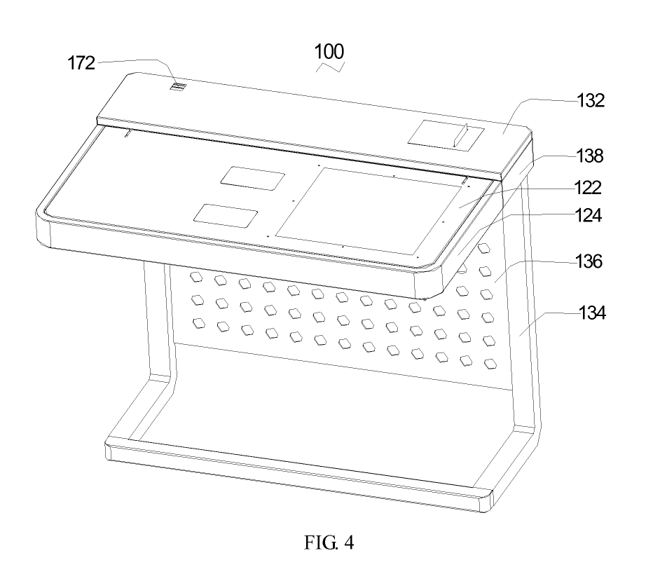

Referring to FIG. 4, when the vehicle-mounted library workstation 100 needs to be in operation state, the front top cover plate 122 is rotated to horizontal state, with the first curved connecting plate 131 and the second curved connecting plate 133 as axis. The first supporting and contracting assembly 126 and the second supporting and contracting assembly 128 are then pulled upward until they slide to the position that the screw 135 is fixed. At last, the screw 135 is fixed. An external power supply will be input to the input plug seat 171, the power adapter of the notebook is plugged in the 3-socket seat 172, the seesaw switch 178 is closed to make the vehicle-mounted library workstation 100 operate.

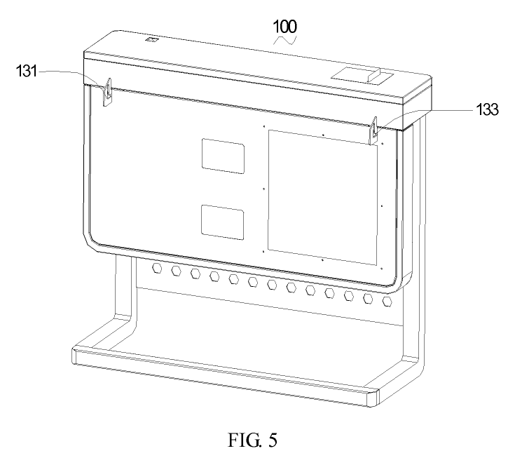

Referring to FIG. 5, when the vehicle-mounted library workstation 100 does not need to operate, the vehicle-mounted library workstation 100 is folded. Firstly, the power adapter of the notebook plugged in the 3-socket seat 172 will be pulled out, then the seesaw switch 178 will be turned off, and the external power will be disconnected from the input plug seat 171, the screw 135 will be disassembled, the first supporting and contracting assembly 126 and the second supporting and contracting assembly 128 will slide away from the screw 135, the front top cover plate 122 will be finally rotated to vertical state, with the first curved connecting plate 131 and the second curved connecting plate 133 as axis. The stuff work station is finally folded.

The vehicle stuff work station system 100 may be folded or unfolded to operate, so the vehicle stuff work station system 100 has advantages of Using conveniently and occupating smaller space.

The vehicle stuff work station system 100 is mainly operated by the library administrator. The flow of borrowing or returning books of the vehicle stuff work station system 100 will be described in details as follows.

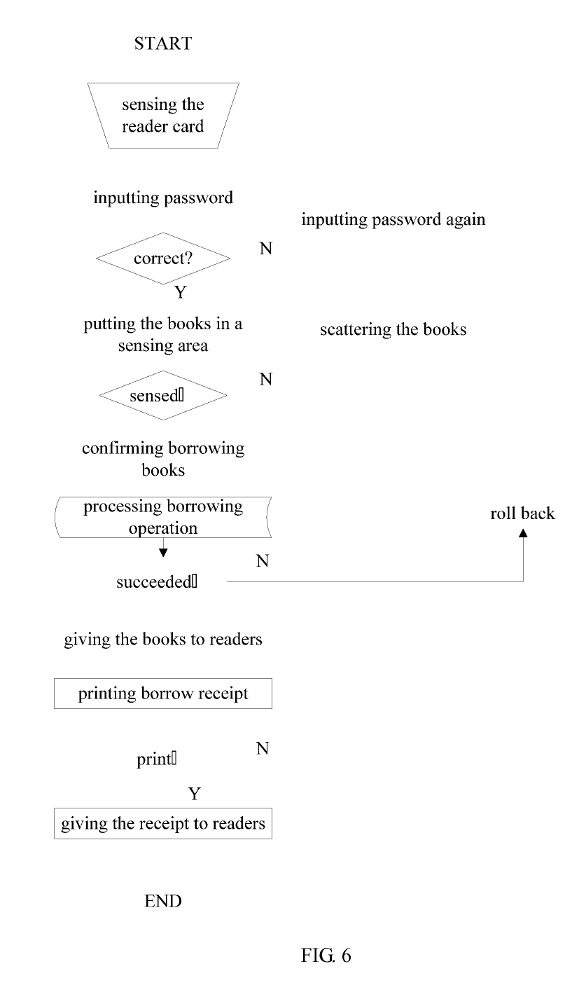

Referring to FIG. 6, when readers are ready to borrow books, the library administrator will select an option of borrowing book from the interface of the notebook screen, the notebook will then response to process and send command signals to drive the reader card reading device 142, which drives the reader card reading antenna 144 to emit wireless signals with predetermined frequency. After the library administrator puts the reader card in the sensing scope of the reader card reading antenna 144, the wireless signals emitted by the reader card reading antenna 144 will sense a RFID chip of the reader card through the related protocol, and collect information stored in the chip. The information is decoded and uploaded to the notebook terminal by the reader card reading device 142, and the screen of the notebook will display the information. The readers input password of the reader card according to the information. The notebook terminal will then upload the password to the library management system via net, and the password will be verified by a background system and a result of the verification will be fed back to the notebook terminal

If the password is incorrect, the notebook terminal will control the interface of the screen to return to a main operation interface. If the password is correct, the interface of the screen will indicate putting the borrowed books in the sensing scope of the book reading antenna 154. Meanwhile, the notebook terminal sends command to drive the book reader 152, which drives the book reading antenna 154 to emit wireless signals with predetermined frequency. The wireless signals emitted by the book reading antenna 154 will sense information stored in RFID tag attached to the borrowed book, and the information is decoded and uploaded to the notebook terminal.

If the readers confirm borrowing books, the notebook terminal will upload the information decoded and uploaded by the book reader 152 to the library management system. The information will be processed by the background system and process result will be returned to the notebook terminal, which controls the screen of the notebook to display the result. If it fails to process successfully, the background system will roll back and the library administrator needs to repeat the borrow operation again. If it processes successfully, the library administrator will pick up books on the front top cover plate 122 where the sensing area of the book reading antenna 154 is located, and the notebook terminal controls the screen of the notebook to display a printing operation. If the readers choose to not print, the interface will return to the main operation interface; if the readers choose to print, the notebook terminal will send command to drive the thermo-sensitive printer 162, which will print a borrow receipt according to the information of borrowing operation recorded by the notebook terminal. Until then, the borrow operation is finished.

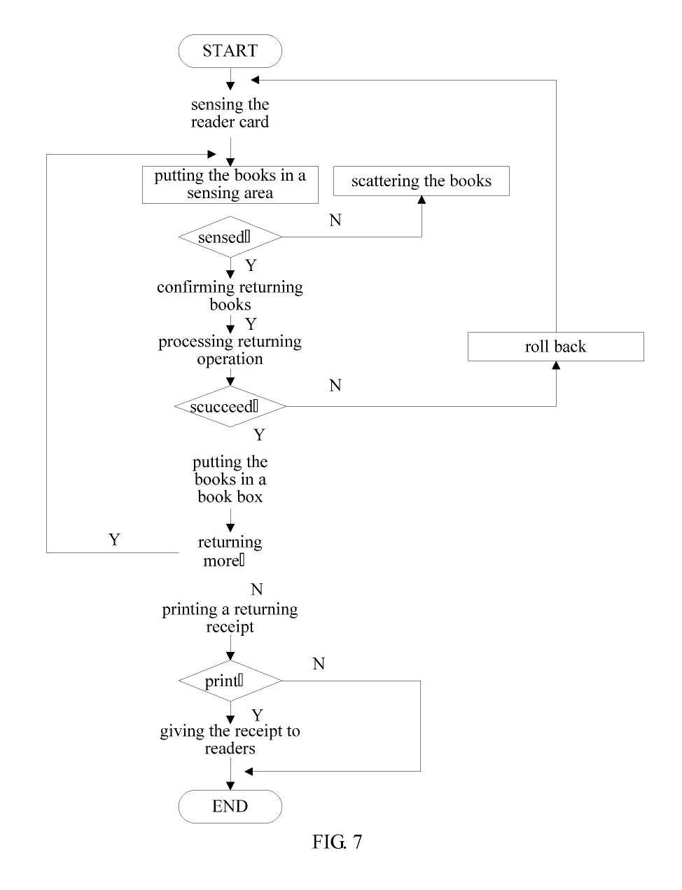

Referring to FIG. 7, when the readers are ready to return books, the library administrator will select an option of returning book from the interface of the notebook screen, the notebook will then response to process and send command signals to drive the reader card reading device 142, which drives the reader card reading antenna 144 to emit wireless signals with predetermined frequency. After the library administrator puts the reader card in the sensing scope of the reader card reading antenna 144, the wireless signals emitted by the reader card reading antenna 144 will sense a RFID chip of the reader card through the related protocol, and collect information stored in the chip. The information is decoded and uploaded to the notebook terminal by the reader card reading device 142. The notebook terminal will upload the information to the library management system via net, and the information will be verified by the background system, the verification result will be returned to the notebook terminal to display.

If the verification is incorrect, the notebook terminal will control the interface of the screen to return to a main operation interface. If the verification is correct, the interface of the screen will indicate putting the borrowed books in the sensing scope of the book reading antenna 154. Meanwhile, the notebook terminal sends command to drive the book reader 152, which drives the book reading antenna 154 to emit wireless signals with predetermined frequency. The wireless signals emitted by the book reading antenna 154 will sense information stored in RFID tag attached to the borrowed book, and the information is decoded and uploaded to the notebook terminal

The library administrator confirms returning books, the notebook terminal will upload the information decoded and uploaded by the book reader 152 to the library management system. The information will be processed by the background system and process result will be returned to the notebook terminal, which controls the screen of the notebook to display the result. If it fails to process successfully, the background system will roll back and the library administrator needs to repeat the borrow operation again. If it processes successfully, the library administrator will pick up books on the front top cover plate 122 where the sensing area of the book reading antenna 154 is located and then put the books in a book box. The notebook terminal controls the screen of the notebook to display a printing operation. If the readers choose to not print, the interface will return to the main operation interface; if the readers choose to print, the notebook terminal will send command to drive the thermo-sensitive printer 162, which will print a return receipt according to the information of returning operation recorded by the notebook terminal Until then, the return operation is finished.

The vehicle-mounted library workstation may also have functions of creating reader cards and modifying information of RFID tags of the books and disks.

When the readers need to create reader cards, the library administrator selects an option of creating a reader card from the interface of the notebook terminal, and the notebook terminal response to process and send command signals to drive the identification card reader 146, which drives the antenna 148 to emit wireless signals with predetermined frequency. After the library administrator puts the identification card in the sensing scope of the antenna 148, the wireless signals emitted by the antenna 148 will sense a RFID chip of the identification card through the related protocol, and collect information stored in the chip. The information is decoded and uploaded to the notebook terminal by the identification card reader 144, and the screen of the notebook will display the information. After the library administrator puts the reader card in the sensing scope of the reader card reading antenna 144, the wireless signals emitted by the reader card reading antenna 144 will sense a RFID chip of the reader card through the related protocol, and collect information stored in the chip. The information is decoded and uploaded to the notebook terminal by the reader card reading device 142. The notebook terminal uploads the information to the library management system. The background system then registers for the reader and return success information for the notebook terminal to display after the registration. The library administrator may choose to charge or print receipt. At last, the reader cards are given to the readers, the creation is finished.

When the administrator needs to modify information of the RFID tags attached to the books or disks, the library administrator selects an option of modifying information of the RFID tags attached to the books or disks, the interface displayed on the screen of the notebook indicates the library administrator to put books in the sensing scope of the book reading antenna 154. Meanwhile, the notebook terminal sends command to drive the book reader 152, which drives the book reading antenna 154 to emit wireless signals with predetermined frequency and read information stored in the RFID tags attached to the returned books. The information is decoded and uploaded to the notebook terminal by the book reader 152. The library administrator modifies the information of the RFID tags, and the modified information will be uploaded to the library management system by the notebook terminal via net. The background system processes the modification and returns the result of the process to the notebook terminal, which controls the screen of the notebook to display the result.

The vehicle-mounted library workstation of the present disclosure is mainly applied in vehicle library system, and it solves the problems of readers from poor and remote district requiring knowledge and information. By arranging books and disks identifying module and reader card identifying module having the RFID function on the shell, the vehicle-mounted library workstation realizes borrowing and returning books. Because of the RFID technology, when the library administrator performs borrowing and returning operation, there is no need to find the bar code and aim it to the scanner, such that the work efficiency is improved. Furthermore, the front assembly of the vehicle-mounted library workstation may be folded or unfolded to work, so it has the advantages of convenience and taking small room.

Although the present disclosure has been described with reference to the embodiments thereof and the best modes for carrying out the present disclosure, it is apparent to those skilled in the art that a variety of modifications and changes may be made without departing from the scope of the present disclosure, which is intended to be defined by the appended claims.

What is claimed is:

1. A vehicle-mounted library workstation, comprising:
a shell;
a books and disks identifying module; and
a reader card identifying module;
wherein the books and disks identifying module comprises a book reading antenna and a book reader for driving the book reading antenna, decoding and transferring data scanned by the book reading antenna; the book reader and reader card reading device are RFID tags readers;
the vehicle-mounted library workstation being connected to a computer while working, wherein the computer controls the reader card identifying module to collect information of the reader card, controls the books and disks identifying module to collect information of the books and disks, and processes the information of the reader card and information of the books or disks to finish operations of borrowing and returning books.

2. The vehicle-mounted library workstation of claim 1, further comprising a printing module.

3. The vehicle-mounted library workstation of claim 1, further comprising a power supply module, which comprises an input plug seat, a seesaw switch, a fusing member, a switching power supply and a 3-socket seat.

4. The vehicle-mounted library workstation of claim 1, further comprising a reader card reading antenna and an identification card reader for driving the reader card reading antenna, decoding and transmitting data scanned by the reader card reading antenna.

5. The vehicle-mounted library workstation of claim 1, wherein the shell is substantially U-shaped.

6. The vehicle-mounted library workstation of claim 1, wherein the shell comprises a front assembly and a rear assembly rotationally fixed on the front assembly.

7. The vehicle-mounted library workstation of claim 6, wherein the front assembly comprises at least a supporting and contracting assembly, which limits the front assembly rotating relatively to the rear assembly while the front assembly stretches.

8. The vehicle-mounted library workstation of claim 6, wherein the front assembly comprises a front top cover plate and a front bottom plate, which together form a house for housing the reader card reading device, the identification card reader and the book reader.

9. The vehicle-mounted library workstation of claim 6, wherein the rear assembly comprises a rear top cover plate and a rear bottom plate, which together form a house for housing a power supply module, a printing module, a reader card reading device, an identification card reader and a book reader.
